(19) United States
(12) Patent Application Publication
(10) Pub. No.: US 2010/0154843 A1
(43) Pub. Date: Jun. 24, 2010

(54) LIQUID APPLICATOR FOR CLEANING A VEHICLE

(76) Inventor: G. Thomas Ennis, Inglewood, CA (US)

Correspondence Address: MATTINGLY & MALUR, P.C., 1800 DIAGONAL ROAD, SUITE 370, ALEXANDRIA, VA, 22314, US

(21) Appl. No.: 12/342,203

(22) Filed: Dec. 23, 2008

(51) Int. Cl. B08B 3/02

(52) U.S. Cl. 134/123

(57) ABSTRACT

A liquid applicator for cleaning a vehicle includes a frame in the form of an arch extending over a path of the vehicle to be washed. Spray pipes are rotatably connected to the sides and top of the arch with the spray pipes being connected by flexible hoses which transmit oscillating rotary movement from one pipe to the other connected pipes. A motor is provided to transmit oscillating rotating movement to one of the spray pipes and cause all of the spray pipes to rotatingly oscillate.

### BACKGROUND OF THE INVENTION

1. Field of the Invention

The present invention relates to an improved liquid applicator for cleaning a vehicle and, more particularly, to such an applicator having an arch with oscillating pipes attached thereto.

2. Description of the Related Art

Vehicle washing devices generally employ means for applying water, detergent and/or other cleaning liquids to a vehicle. Such means often include a plurality of pipes mounted at the sides and at the top of the frame of the device extending over the path of the vehicle to be washed. Often these pipes have spray nozzle attached thereto for spraying cleaning liquid straight out at the vehicle as it passes thereby. Other such prior art devices use high pressure jet spinner nozzles connected to pipes mounted to a frame as shown in my U.S. Pat. No. 5,463,788. There remains a need for a liquid applicator for use in connection with the vehicle washing apparatus which adequately applies a cleaning fluid to a vehicle as it is being washed.

### SUMMARY OF THE INVENTION

It is an object of the present invention to provide a liquid applicator for applying a cleaning liquid to a vehicle which provides better washing coverage while using less cleaning liquid, including water.

It is another object of the present invention to provide a liquid applicator for applying a cleaning liquid to a vehicle which employs oscillating spray pipes having nozzles attached thereto.

A further object of the present invention is to provide a liquid applicator for applying a cleaning fluid to a vehicle which includes a frame in the form of an arch extending over the path of the vehicle to be washed and which has oscillating spray pipes attached to the arch.

The present invention achieves the above and other objects by providing a liquid applicator for cleaning a vehicle which includes a frame extending over the path of the vehicle to be washed. The frame has a first vertical frame member on one side of the path, a second vertical frame member on an opposite side of the path and a third horizontal top frame member connected at one end to an upper portion of the first vertical frame member and at an opposite end to an upper portion of the second vertical frame member whereby the frame members form an arch extending over the path of the vehicle. A first spray pipe is rotatably mounted to the first vertical frame member and a second spray pipe is rotatably mounted to the second vertical frame member. A third spray pipe is rotatably mounted to the third horizontal top frame member. A first flexible hose rotatably connects an upper end of the first spray pipe to a first end of the third spray pipe and a second flexible hose rotatably connects an upper end of the second spray to a second end of the third spray pipe. A motor is connected to one of the spray pipes to transmit oscillating rotating movement to the one spray pipe and cause all three of the spray pipes to rotating oscillate while applying a cleaning liquid to a vehicle being washed.

The first and second flexible hoses preferably are comprised of a reinforced rubber hose. Spray nozzles are attached to the spray pipes and may be in the form of pairs of nozzles mounted to a plurality of spaced manifolds connected to the spray pipes. A ball valve is mounted at a lower end of each of the first and second spray pipe to flush out the spray pipes.

These, together with other objects and advantages, which will be subsequently apparent, reside in the details of construction and operation as more fully described and claimed hereafter, reference being made to the accompanying drawings forming a part hereof, wherein like numerals refer to like parts throughout.

### BRIEF DESCRIPTION OF THE DRAWINGS

FIG. 1 is a front elevational view of a liquid applicator for cleaning a vehicle according to the present invention;

FIG. 2 is a left side elevational view of the liquid applicator shown in FIG. 1;

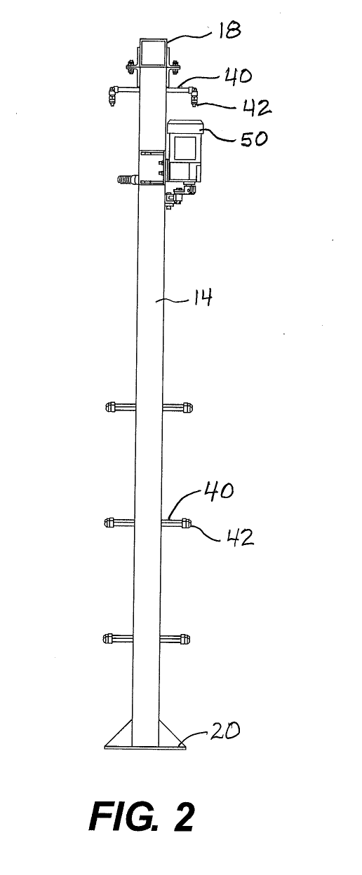

FIG. 3 is a top plan view of the liquid applicator shown in FIG. 1;

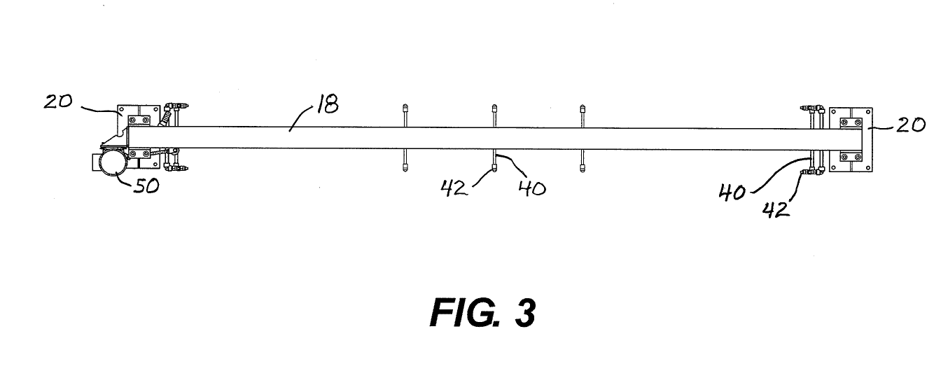

FIG. 4 is an enlarged front view of a portion of the liquid applicator shown in FIG. 1 showing a motor attached to the frame of the applicator and operatively connected to a spay pipe for imparting oscillating rotary movement thereto;

FIG. 5 is an enlarged front view showing the lower portion of a vertical spray pipe of the liquid applicator of FIG. 1 having a manifold with nozzles and a ball valve attached thereto;

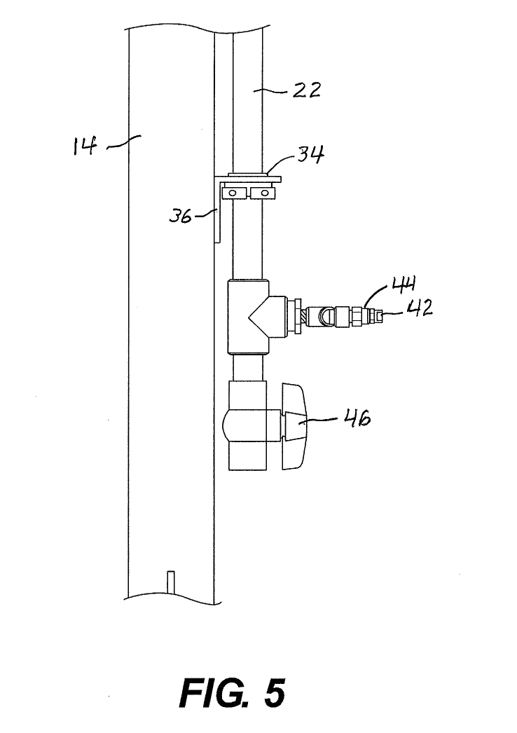

FIG. 6 is an enlarged perspective view of a tee shaped manifold having a spray nozzle on each end thereof; and

FIG. 7 is enlarged perspective view showing the motor of the liquid applicator and the manner in which it is connected to a vertical spray pipe to impart oscillating rotary movement thereto.

### DETAILED DESCRIPTION OF THE PREFERRED EMBODIMENTS

Referring to the drawings, a liquid applicator for cleaning a vehicle, generally referred to by the numeral 10, is shown which includes a supporting frame 12 in the form of an arch extending over the path or position of a vehicle to be washed. The frame includes a first vertical frame member 14 on one side of the path of the vehicle, a second vertical frame member 16 on an opposite side of the path of the vehicle and a third horizontal top frame member 18 connected at one end to an upper portion of the first vertical frame member and at an opposite end to an upper portion of the second vertical frame member to form the arch extending over the vehicle path. Each vertical frame member 14 and 16 is provided with a base plate 20 at the bottom thereof to support the frame 12 on any suitable surface. The base plate 20 may be bolted or otherwise secured to a suitable surface such as concrete.

A first spray pipe 22 is rotatably mounted to the first vertical frame member 14 on the inside thereof and a second spray pipe 24 is rotatably mounted to the second vertical frame member 16 on the inside thereof. A third top horizontal spray pipe 26 is rotatably mounted to the third top horizontal frame member 18.

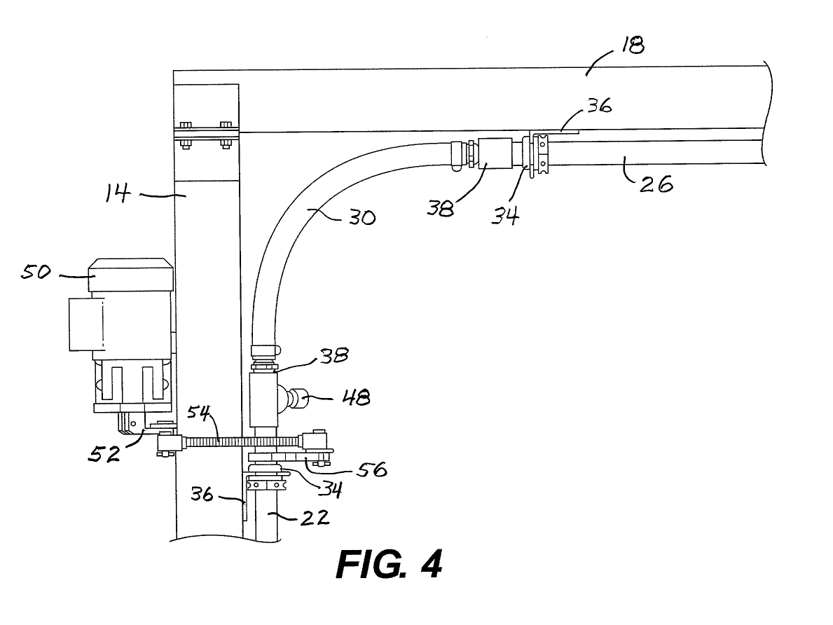

The upper end of first spray pipe 22 is connected to an outer end of the third top spray pipe 26 by a flexible connecting hose 30 and the upper end of the second spray pipe 24 is connected to an opposite end of the top third spray pipe by another flexible connecting hose 32. Preferably, the flexible hoses 30 and 32 are constructed of a durable reinforced rubber material. While the hoses may be made of other materials such as plastic, a flexible hose of a durable reinforced rubber material is preferred since it has a longer life when used to transmit an oscillating rotating motion. As shown in FIG. 4, the ends of the flexible hoses 30 and 32 are connected to the spray pipes by means of a coupling 38 having a hose barb which is inserted into the end of the hose to ensure that the hose is fixedly secured to transmit rotation from one pipe to another pipe.

The spray pipes 22, 24 and 26 are attached to the frame members 14,16 and 18 by brackets 36 having collars 34 of ultra high molecular weight (UHMW) plastic mounted therein whereby the pipes may rotate within the collars. The brackets 36 may be made of a suited metal such as aluminum.

The frame members 14, 16 and 18 are preferably in the form of rectangular metal tubes, preferably made from aluminum, and are connected together by suitable fastening means such as bolts.

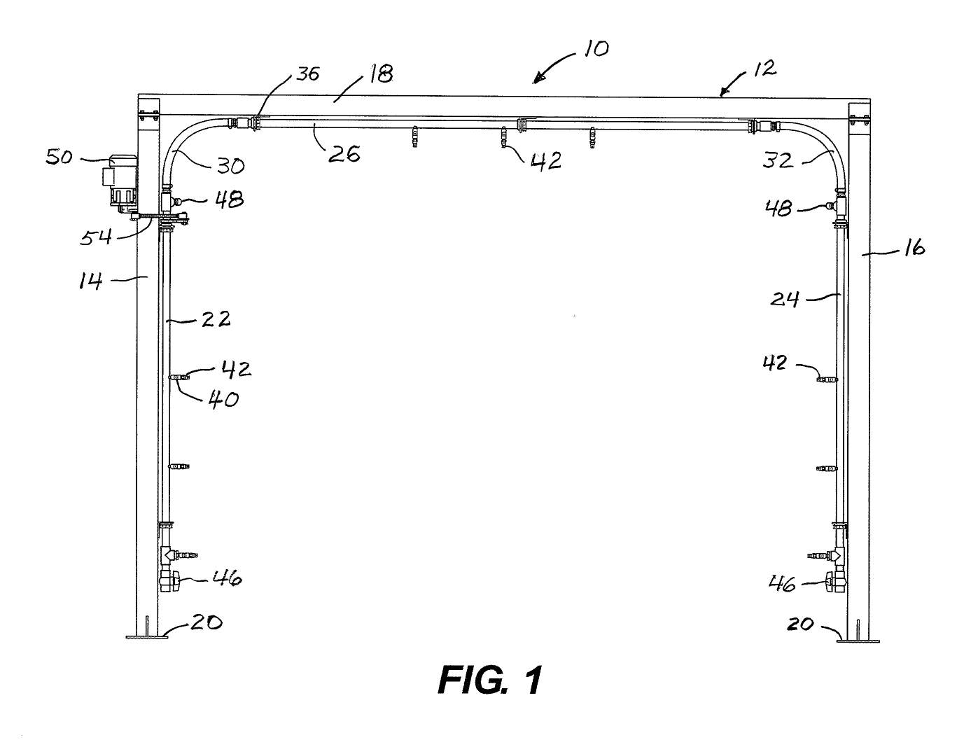

Each of the vertical spray pipes 22 and 24 are provided with a ball valve 46 at their lower ends so that the pipes may be flushed out to remove debris and the like when the valves are opened. As shown in FIGS. 1 and 4, suitable connections 48 are provided to permit green liquids such as water and detergents to be added to the applicator from suitable sources of supply.

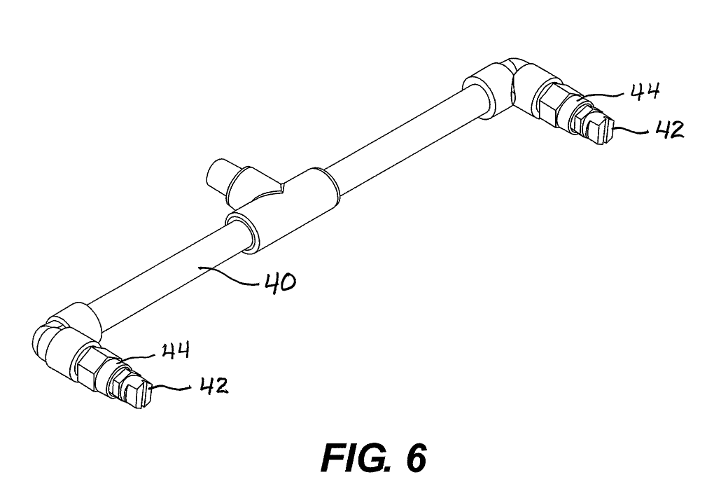

A plurality of spray nozzles 42 are attached at spaced locations to spray pipes 22, 24 and 26. Dual nozzle tee manifolds 40 are provided which connect the nozzles and pairs to the spray pipes. A manifold 40 having a nozzle 42 at each end thereof is shown in detail in FIG. 6. Each of the nozzles 42 is also provided with a check valve 44 to minimize water and detergent consumption and to provide instant activation.

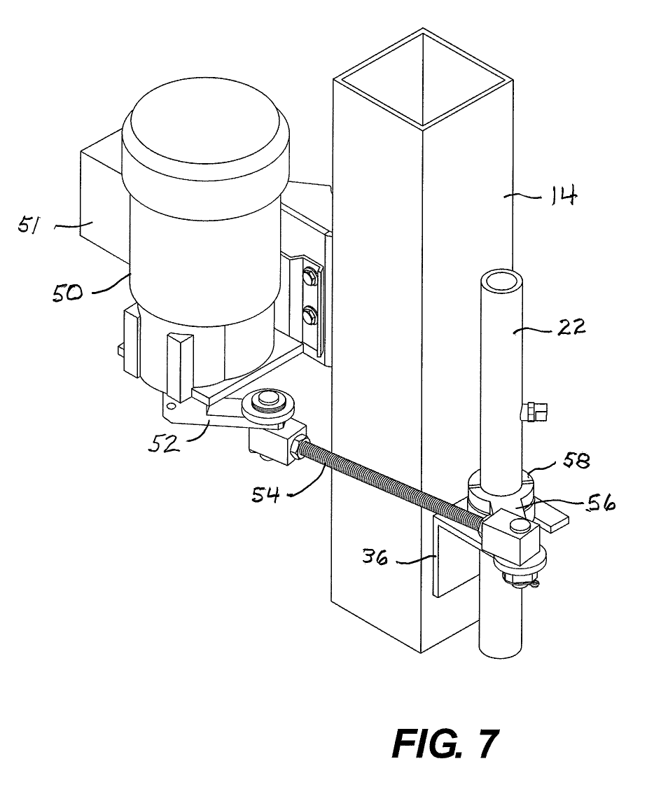

As most clearly shown in FIGS. 4 and 7, a suitable motor 50 is mounted to first vertical frame member 14 adjacent a top thereof for transmitting oscillating rotary movement to the spray pipes. Preferably the motor is an electric motor but other suitable motors may also be utilized. While the motor 50 is shown mounted to the first vertical frame member 14 and connected to the first spray pipe 22, a motor alternatively also could be mounted on the second vertical pipe 16 and connected to the second spray pipe 24 or to the third top horizontal frame member 18 and connected to the spray pipe 26.

The motor is provided with a crank arm 52 at the bottom thereof which in turn is rotatably connected to one end of a threaded connecting rod 54. The opposite end of the connecting rod 54 is rotatably connected to a second crank arm 56 which in turn is connected to spray pipe 22 by suitable collar means 58.

The motor 50 is mounted by suitable fastening means such as bolts to a bracket 51 which in turn is mounted to the outside face of vertical frame member 14 as shown in FIG. 7.

In operation of the liquid applicator, a suitable source of a cleaning liquid such as a combination of water and detergent is connected to the applicator and the electric motor is activated to cause the crank arm 52 to rotate which in turn transmits movement through the threaded connecting rod 54 to the pipe crank arm 56. The pipe crank arm 56 then transmits the oscillating rotative movement to first spray pipe 22. The oscillating movement of the pipe 22 is then transmitted by the first flexible hose 30 to the third spray pipe 26 which in turn transmits the oscillating rotative movement to the second flexible hose 32. The second flexible hose 32 then transmits the oscillating rotative movement to the second spray pipe 24.

The crank arm on the motor turns 360 degrees and this in turn transmits rotative movement to the first spray pipe 22 so that the pipe will rotate a desired amount with at least 35 degrees of rotation being preferred.

The oscillating movement of the spray pipes provide several advantages. By having the pipes oscillate forwardly, the cleaning liquid wets the vehicle prior to the vehicle actually advancing to the position of the spray pipe whereby the liquid hits the vehicle at a first forward angle. As the vehicle continues to move past the spray pipes, the liquid hits the vehicle head on in a straight direction and as the vehicle continues to move past the spray pipes, the liquid then hits the vehicle at a second backward angle. By having the water hit the vehicle at two different angles, it helps clean the areas which are otherwise difficult to access such as rear view mirrors where the liquid contacts both the front and rear of the mirrors. Moreover, the liquid applicator uses less water to clean the vehicle because it contacts the vehicle in a larger area due to the rotation then if the cleaning liquid hits the vehicle head on.

While not shown in the drawings, the liquid applicator may be controlled to start and start by an electronic sensor which senses the movement of the vehicle. Moreover, the use of the flexible hose connections to connect the spray pipes for oscillating movement, permits the use of a single motor to oscillate all the spray pipes on the sides and the top.

Although not shown in the drawings, the motor 50 also may be provided with a cover to protect it from the spray of cleaning liquids and other debris. Numerous other modifications and adaptations of the present invention will be apparent to those skilled in the art and thus, it is intended by the following claims, to cover all such adaptations which fall within the true spirit and scope of the invention.

What is claimed is:

1. A liquid applicator for cleaning a vehicle comprising:
a frame extending over a path of a vehicle to be washed;
a first spray pipe rotatably mounted to one side of said frame on one side of said path;
a second spray pipe rotatably mounted to an opposite side of said frame on an opposite side of said path;
a third spray pipe rotatably mounted to a top of said frame and extending over said path;
a first flexible hose rotatably connecting an upper end of said first spray pipe to a first end of said third spray pipe;
a second flexible hose rotatably connecting an upper end of said second spray pipe to a second end of said third spray pipe; and
a motor connected to one of said spray pipes to transmit oscillating rotating movement to said one spray pipe and cause all three of said spray pipes to rotatingly oscillate.

2. The liquid applicators according to claim 1 wherein said first and second flexible hoses each comprise a reinforced rubber hose.

3. The liquid applicator according to claim 1 which further comprises spray nozzles attached to said spray pipes.

4. The liquid applicator according to claim 3 wherein said nozzles are attached in pairs to a plurality of spaced manifolds connected to said spray pipes.

5. The liquid applicator according to claim 1 which further comprises a ball valve mounted at a lower end of each of said first and second spray pipes to flush out the spray pipes.

6. A liquid applicator for cleaning a vehicle comprising:
a frame extending over a path of a vehicle to be washed, said frame having a first vertical frame member on one side of said path, a second vertical frame member on an opposite of said path and a third horizontal top frame member connected at one end to an upper portion of said first vertical frame member and at an opposite end to an upper portion of said second vertical frame member whereby said frame members form an arch extending over said path;
a first spray pipe rotatably mounted to said first vertical frame member;
a second spray pipe rotatably mounted to said second vertical frame member;
a third spray pipe rotatably mounted to said third horizontal top frame member;
a first flexible hose rotatably connecting an upper end of said first spray pipe to a first end of said third spray pipe;
a second flexible hose rotatably connecting an upper end of said second spray pipe to a second end of said third spray pipe; and
a motor connected to one of said spray pipes to transmit oscillating rotating movement to said one spray pipe and cause all three of said spray pipes to rotatingly oscillate.

7. The liquid applicator according to claim 6 wherein said first and second flexible hoses each comprise a reinforced rubber hose.

8. The liquid applicator according to claim 6 which further comprises spray nozzles attached to said spray pipes.

9. The liquid applicator according to claim 8 wherein said nozzles are attached in pairs to a plurality of spaced manifolds connected to said spray pipes.

10. The liquid applicator according to claim 1 which further comprises a ball valve mounted at a lower end of each of said first and second spray pipes to flush out the spray pipes.
